(19) United States
(12) Patent Application Publication
(10) Pub. No.: US 2026/0064856 A1
(43) Pub. Date: Mar. 5, 2026

(54) SYSTEM AND/OR METHOD FOR TIME-BASED RISK ASSESSMENT IN AN AUTONOMOUS AGENT

(71) Applicant: May Mobility, Inc., Ann Arbor, MI (US)

(72) Inventors: Jacob Crossman, Ann Arbor, MI (US); Collin Johnson, Ann Arbor, MI (US); Juan Pablo Gonzalez, Ann Arbor, MI (US)

(73) Assignee: May Mobility, Inc., Ann Arbor, MI (US)

(21) Appl. No.: 19/319,447

(22) Filed: Sep. 4, 2025

Related U.S. Application Data
(60) Provisional application No. 63/690,306, filed on Sep. 4, 2024.

(51) Int. Cl. G06F 21/57

(52) U.S. Cl. CPC G06F 21/577; G06F 2221/034

(57) ABSTRACT

A method for risk-aware policy assessment for an autonomous vehicle can include: collecting information associated with an environment of an ego vehicle; determining a set of policy proposals; determining and assessing a set of risks encounterable (e.g., potentially encountered in the future) by the ego vehicle; selecting a policy based on the set of risks, operating the ego vehicle based on the assessed risks, and/or any other suitable elements. Additionally or alternatively, the method can include any or all of: performing a set of simulations, analyzing the simulation results, determining a set of discount profiles, discounting a set of risks, and/or any other processes. The method can be performed with a system as described below and/or any other suitable system.

### CROSS-REFERENCE TO RELATED APPLICATIONS

This application claims the benefit of U.S. Provisional Application No. 63/690,306, filed 4 Sep. 2024, which is incorporated herein in its entirety by this reference.

This application is related to U.S. application Ser. No. 18/672,328, filed 23 May 2024, which is a continuation of U.S. application Ser. No. 18/538,312, filed 13 Dec. 2023, which claims the benefit of U.S. Provisional Application No. 63/432,137, filed 13 Dec. 2022, and U.S. Provisional Application No. 63/442,636, filed 1 Feb. 2023, each of which is incorporated herein in its entirety by this reference.

This application is related to U.S. application Ser. No. 19/269,394, filed 15 Jul. 2025, which claims the benefit of U.S. Provisional Application No. 63/675,606, filed 25 Jul. 2024, each of which is incorporated herein in its entirety by this reference.

### TECHNICAL FIELD

This invention relates generally to the vehicle automation field, and more specifically to new and useful systems and methods for selecting behavioral policy by an autonomous agent in the vehicle automation field.

### BRIEF DESCRIPTION OF THE FIGURES

FIG. 1 is a schematic representation of a variant of the system.

FIG. 2 is a schematic representation of a variant of the system with an example risk model.

FIG. 3 is a flowchart diagrammatic representation of a variant of the method.

FIG. 4 is a flowchart diagrammatic representation of a variant of the method.

FIG. 5 is an example flowchart diagram for a policy election cycle in one or more variants of the method.

FIG. 6 illustrates example discount profiles based on temporal response optionality in one or more variants of the method.

FIG. 7 is a schematic representation of a variant of the risk model.

FIG. 8 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

A system 100 (e.g., a system onboard an autonomous vehicle, etc.) can include a sensor suite 160, a computing system 170, a vehicle control system 180 and/or any other suitable components. In variants, the computing system 170 can execute a multi-policy decision-making model 101, a risk model 102, policies 110 (e.g., made up at least of policy elements in, etc.), and/or any other suitable system components. The system can determine and/or use a risk profile 10 and/or a discount profile 20 to determine a weighted risk profile 30 for evaluation of risks during a multi-policy decision-making (MPDM) cycle.

A method 200 for risk-aware policy assessment for an autonomous vehicle can include: collecting information associated with an environment of an ego vehicle S100; determining a set of policy proposals S200; determining and assessing a set of risks encounterable (e.g., potentially encountered in the future) by the ego vehicle S300; selecting a policy based on the set of risks S400, operating the ego vehicle based on the set of risks S500, and/or any other suitable elements. Additionally or alternatively, the method 200 can include any or all of: performing a set of simulations S310, analyzing the simulation results S320, determining a set of discount profiles S330, discounting a set of risks S340, and/or any other processes. The method 200 can be performed with a system 100 as described below and/or any other suitable system.

The autonomous vehicle preferably assesses risks for each policy (by simulation) based on the temporal urgency and/or temporal response optionality associated with the risk scenario. Risk assessments (e.g., weighted risk profiles 30, etc.) may discount risks, particularly of low probability, which are sufficiently far into the future that the vehicle could respond to mitigate them in future election cycles (i.e., the vehicle retains decision optionality within the current cycle and/or future cycles). As the response optionality and/or temporal urgency of the risk scenario increases, weights of a discount profile 20 can be adjusted (e.g., increased) such that when combined with (e.g., multiplied by) a risk profile 10, a resultant weighted risk profile 30 can factor more urgent risks into policy evaluation/scoring (e.g., increasing a set of discount weights as a function of temporal proximity, where imminent risks are fully weighted, into policy scoring). The discount profile 20 is preferably determined based on the current ego vehicle state and/or policy parameters. For example, the discount profile 20 can be a function of: ego vehicle speed, the current speed limit, the current acceleration, time drift (e.g., vehicle response latency), maximum brake effort (e.g., defined based on passenger comfort, vehicle limits, etc.), and/or any other suitable parameters. As a second example, the discount profile 20 can be a function of the envelope protections and/or performance limits for a given vehicle state (e.g., vehicle's ability to react and stop before a future risk). Temporal response optionality is preferably evaluated based on longitudinal motion (e.g., based on forward acceleration and braking) rather than lateral motion (e.g., steering adjustments), since lateral motion may be inherently analyzed within the various policy proposals (e.g., shifting within the lane or changing lanes may already be considered by a risk-mitigating reward functions). Additionally, longitudinal control (e.g., braking) may generally be favored as a risk mitigation measure across most encounterable risk scenarios. However, the discount profile(s) can be otherwise determined, and/or can consider any suitable combinations of lateral and longitudinal effort.

The discount profile 20, as determined during risk assessment via S330 or otherwise, is preferably used for policy selection (e.g., S400) and/or vehicle operation (e.g., S500). Additionally or alternatively, the discount profile 20 can be used to determine (e.g., generate) policy proposals in future election cycles (e.g., via S200), and/or can be otherwise used.

The autonomous vehicle may incorporate risk awareness when determining and/or refining multiple types of policies during each election cycle. The policies can include: generative policies (e.g., dynamically determined/generated based on prior risk analysis and most pertinent risks/constraints, such as temporal risk assessment, as in U.S. application Ser. No. 19/269,394, filed 15 Jul. 2025, which is incorporated herein in its entirety by this reference), context-based policies (e.g., deterministic and/or predetermined for a given driving context), and/or fallback/emergency policies (e.g., predetermined for given failure cases). In particular, risk awareness can be used to generate and/or refine policies based on the most relevant (urgent) risks and/or a reward function, which may frequently yield more favored elections (e.g., higher reward behaviors) within the computing constraints of an election cycle (e.g., with a frequency on the order of 5-10 Hz) and/or globally (e.g., across multiple election cycles). The term ‘policy’ (and/or ‘policy candidate’ and/or ‘policy proposal’) and/or ‘behavior policy’ as utilized herein preferably refers to a set of control laws (e.g., a controller which can be simulated by MPDM and/or executed by the vehicle control system), but can additionally or alternatively refer to vehicle behaviors, actions, and/or any other suitable policies. For example, policies can be as described in U.S. application Ser. No. 16/514,624, filed 17 Jul. 2019, U.S. application Ser. No. 17/365,538, filed 1 Jul. 2021, and/or U.S. application Ser. No. 18/538,312, filed 13 Dec. 2023, each of which is incorporated herein in its entirety by this reference. However, the term policies can be otherwise suitably used/referenced herein.

The term “substantially” as utilized herein can mean: exactly, approximately, within a predetermined threshold or tolerance, and/or have any other suitable meaning.

### 1.1 Illustrative Example

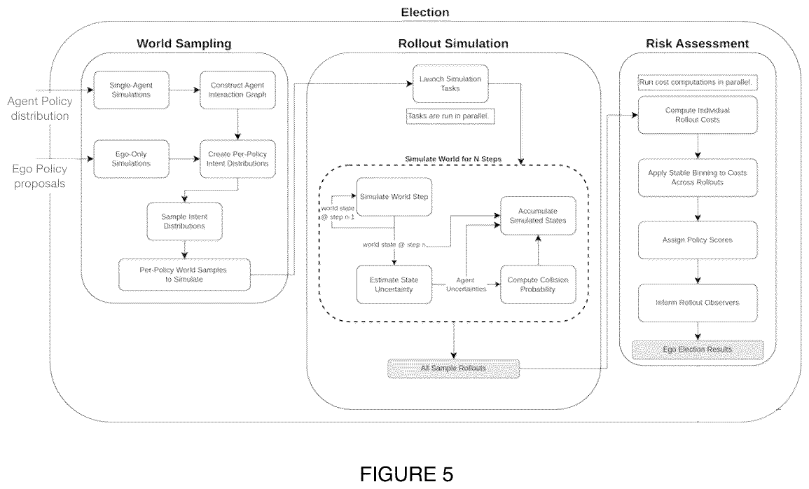

Per-policy MPDM simulation rollouts are preferably indexed in time (e.g., an example implementation of rollout simulation is shown in FIG. 5). Each state within a rollout can be analyzed to compute a risk profile 10 including a set of risk values as a function of time (e.g., with the simulated state as the initial condition for risk estimation/analysis). The state(s) of the ego vehicle within the rollout can be analyzed to determine a discount profile 20 (e.g., dynamic/deterministic, etc.) as a function of time, which can be multiplied by the risk value(s) to adjust for temporal response optionality for the given ego state, risk, and/or policy; thereby determining a weighted risk profile 30.

The discount profile 20 can be entirely independent of the risk values (e.g., in some variants, risks need not be classified, binned, or aggregated to incorporate the notion of response-optionality as part of the risk assessment) and/or may depend on one or more risk values (e.g., such as potential risk event probability). Additionally or alternatively, a separate discount profile(s) can be determined to account for one or more of: ego risk within the scene, per agent risk, groups of agents, and/or any other suitable subset(s) or combination(s) of agents. In such variants, each discount profile(s) could be applied to a respective risk value (analyzing a respective subsets of agents in the scene; per agent risk value as a function of time multiplied with a discount profile as a function of time, etc.).

Additionally or alternatively, a discount profile can additionally be determined based on event probability, where potential risk events could be binned across rollouts at some time index to yield the aggregate probability, which could then be used to determine a corresponding discount profile (e.g., as a function of both time and probability; discrete discount factor/coefficient for each timestep; etc.).

In a specific example, during MPDM simulation, the vehicle system (e.g., the computing system thereof) can simulate each of multiple candidate behavior policies using multiple simulations for each policy (e.g., where between simulations, the policies of other agents in the scene differ). For each simulation, control effort expended by the ego vehicle and/or other agents in the scene (e.g., risk severity) can be determined and binned alongside control effort values from other simulations, thereby producing an aggregate risk profile including expected control effort at each of a set of future timesteps in a planning horizon for each policy. The policy-specific risk profiles can be weighted according to a dynamically-determined discount function (e.g., based on vehicle kinematics and limitations, etc.), aggregated, and compared to one another, such that the MPDM model can select a policy based on the aggregated values (e.g., selecting a minimal risk policy, etc.).

In a first illustrative example, a method can include: based on a set of measurements depicting a set of agents in an environment surrounding the vehicle, determining a virtual representation of the set of agents; determining a set of candidate behavior policies for the vehicle; during vehicle operation, for a candidate behavior policy of the set of candidate behavior policies: based on the candidate behavior policy and the virtual representation of the set of agents, dynamically determining a risk profile associated with the set of agents, the risk profile representing risk at each of a set of timesteps in a planning horizon; dynamically determining a set of risk discount profiles, wherein each risk discount profile varies over timesteps in a planning horizon; and according to the set of risk discount profiles, determining a set of weighted risk parameters for the risk profile; based on the set of weighted risk parameters, selecting the candidate behavior policy from the set of candidate behavior policies; determining a set of vehicle controls based on the selected candidate behavior policy; and using the set of vehicle controls, controlling the vehicle.

In a second illustrative example, a method can include: during vehicle operation: dynamically determining a risk profile associated with a set of agents in an environment of the vehicle, wherein each risk parameter of the risk profile corresponds to a respective timestep in a planning horizon; dynamically determining a risk discount profile, wherein weights of the risk discount profile vary over timesteps in a planning horizon; and according to weights of the risk discount profile, determining a set of weighted risk parameters for the risk profile; based on the set of weighted risk parameters, selecting a candidate behavior policy from a set of candidate behavior policies; and controlling the vehicle based on the selected candidate behavior policy.

### 2. Benefits

Variations of the technology can afford several benefits and/or advantages.

First, variations of this technology can utilize forward simulations to account for the risks (and/or control effort associated therewith) associated with future scenarios (equivalently referred to herein as futures) which may be encountered by an autonomous vehicle under a candidate policy(ies). More preferably, variants can assess risks based on temporal urgency and future response optionality. For instance, the ego vehicle may pursue policies with potential for extremely severe consequences in cases where the corresponding risk factors are temporally distant: a severe risk factor in the distant future (e.g., such as ten or more seconds in the future) may be functionally ignored, since the ego vehicle retains the ability to further analyze and respond well in advance of the risky scenario. In particular, overly conservative responses may be completely avoided in cases of ‘phantom’ risks in the distant future, since many low-probability, high-severity risk factors may cease to exist while the vehicle retains the ability to react to said risk factors (i.e., before the vehicle needs to react in order to avoid the risk scenario).

Second, variations of this technology can enable an autonomous vehicle to operate by performing behaviors more similar to behaviors exhibited by human drivers operating a manually driven vehicle. In particular, by representing risk as a proxy for control effort, the vehicle can make elect policies based on minimizing control effort (e.g., braking, jerking, etc.) directly. Policies determined based on elective cost functions which consider the temporal nature of future risks may frequently yield more favorable policy elections (e.g., higher reward behaviors which align more closely with a navigation target) within the computing constraints of an election cycle and thus result in driving behaviors which more closely resemble ‘human’ driving behaviors. As a result, the vehicle can exhibit more naturalistic driving behavior, leading to a smoother, more comfortable ride for passengers.

Third, variations of the technology can enable the vehicle control system to consider a broader range of risk types than conventional methods, as high-severity, low-probability risks in the far future can be de-weighted. Such de-weighting can enable the vehicle to focus on higher more urgent and/or imminent risks of different types that the vehicle is currently facing or will soon face. Such variants can enable a spectrum and/or multitude of risk types, risk severities, and/or risk urgencies to be considered and assessed, rather than using only the most severe risks (e.g., potential collisions) in the vehicle's decision making, which can conventionally lead ego vehicles to exhibit overly conservative, unpredictive, progress-hindering behaviors. Variants of the method can involve considering multiple types of risks, such as, but not limited to: collision risk, conflict risk (e.g., the potential for the ego vehicle to be in a risk-heavy region with another agent, the potential for the ego vehicle to cross paths with another object, etc.), clearance risk (e.g., insufficient spacing between the vehicle and other agents in the scene), infrastructure risk (e.g., risks associated with disobeying bounds of the road) and/or any other risks. Additionally or alternatively, variants can determine weighted risk profiles that not only reflect the ego vehicle's future risk, but also (or alternatively) risk relating to objects in the ego's environment and their abilities to (1) mitigate risk from their perspective (e.g. braking to avoid the ego vehicle, braking to avoid another object, etc.) and (2) mitigate risk caused by environmental objects interacting with each other (e.g., when the ego is not involved at all). In examples, this prediction can be enabled though any or all of: the different types of simulations (e.g., simulations where ego is absent), the analysis of the likelihood of different predicted scenarios, the incorporation of prediction uncertainties in simulations when calculating weighted risk profiles and/or values thereof, and/or any other features of the system and/or method.

Fourth, variations can utilize time-based risk analysis (e.g., from a previous election cycle) to generate and/or refine risk-aware policies which may be more likely to yield favorable evaluations within a current decision cycle (e.g., favorable cost function under updated risk analysis and simulation for a current election cycle). For instance, prior risk analysis can be used to construct policies (e.g., as a set of control laws) which address the most impactful risk factors in the future scenarios (e.g., relative to a cost function, reward, etc.), which can then be simulated to select the most favorable within the current environment (e.g., MPDM for a given election cycle) in view of any second order effects or emergent risk factors (e.g., as may arise from an intervening change in environment and/or policy candidates). In variants, by using the weighted risk profile 30 which incorporates discount weights (e.g., of the discount profile 20), variations of the technology can generate policies based mostly on risks the vehicle is facing or will soon face.

Sixth, variations of the technology can dynamically adjust risk assessment based on the ego vehicle's current performance envelope and capabilities. Factors such as current kinematics, road conditions, and vehicle health status can inform the discount profile calculations, resulting in a risk profile that matches the vehicle's current capability to respond. This dynamic adjustment may result in more conservative behaviors when operating under degraded or otherwise unfavorable conditions (e.g., rain and slick roads).

However, variations of the technology can additionally or alternately provide any other suitable benefits and/or advantages.

### 3. System

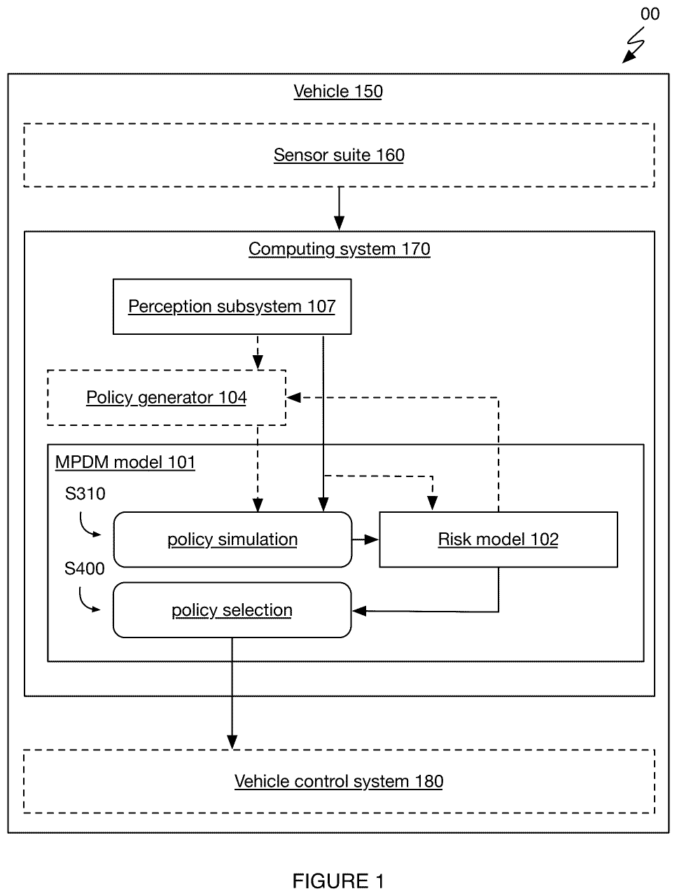

The system 100, an example of which is shown in FIG. 1, can include a computing system, an optional sensor suite 160, an optional vehicle control system 180, and/or any other suitable set of components. The computing system can include a set of models, which can include: an optional policy generator 104, a Multi-Policy Decision-making Model 101 (MPDM model), a Risk Model 102 (RM), and/or any other suitable set of elements. However, the system 100 can additionally or alternatively include any other suitable set of components. The system can function to select a behavior policy for the vehicle based on a set of future simulations and a (time-based) weighted risk profile 30. Additionally or alternatively, the system can function to determine (e.g., generate) risk-aware behavior policies based on prior risk profiles. Additionally or alternatively, the system can function to execute the method 200 and/or can perform any other suitable function(s).

Risk as assessed by the system can model general risk (e.g., risk as a measure of overall current risk in the scene), individualized risk (e.g., specific, identified risks and/or agents associated therewith, etc.), and/or any other suitable basis for risk. The risks are preferably determined by the risk model 102 but can alternatively be determined by the simulation engine or any other suitable system component. The risks are preferably determined in S310, S320 and/or S340 but can alternatively be determined at any other suitable time. “Risk,” and/or “risk values” (alternatively referred to as “risk parameters) as used herein can refer to general risk and/or individualized risk; and/or parameters associated therewith.

In preferred variations (‘general risk’ variations), risk as assessed by the system can refer to general risk in the scene (e.g., for a particular policy; which may be scored/evaluated as a function of time), such a may be estimated as by the magnitude of resulting control effort (braking, steering, etc.) expended in simulated rollout[s]. For example, for a set of multiple simulations with a planning horizon of 15 seconds, if multiple simulations of a first ego vehicle policy include jerky vehicle motion at time window spanning between 5 and 8 seconds from a current time, whereas simulations of a second ego vehicle policy do not include jerky vehicle motion over the same time window, a first risk profile associated with the first ego vehicle policy can include a region (e.g., between 5 and 8 seconds from a current time) which has higher risk values than a corresponding region in a second risk profile associated with the second policy.

In another variation (e.g., ‘individualized risk variation’), risks, as assessed by the system 100, can refer to risky events/situations that may be encountered by the ego vehicle and/or another set of agents in the scene. For example, risks can be associated with a particular environmental object(s) (e.g., environmental agent, static environmental feature, lane boundary feature, etc.), locations, times, severity levels, probabilities, weights, and/or any other suitable information. In a first example, a single risk can be associated with multiple environmental objects (e.g., 1:N; in which each environmental object each poses the same risk, where the environmental objects cooperatively define a risk, such as a clearance risk between two close vehicles, etc.). In a second example, multiple risks can be associated with a single environmental object (e.g., N:1; in which the ego vehicle is at risk of conflicting and/or colliding with an environmental object, etc.). In a third example, a single risk can be associated with a single environmental object (e.g., 1:1). However, risks and objects can be associated in any other suitable ratio. Risk classes can include collision risks (e.g., potential impacts with other environmental objects), conflict risks (e.g., time or space conflicts where multiple environmental objects may occupy the same region), clearance risks (e.g., insufficient lateral or longitudinal spacing between the ego vehicle and environmental objects), and infrastructure risks (e.g., risks associated with road geometry, traffic control devices, or lane boundaries). Each risk can be represented within a weighted risk profile by one or more risk values including: the risk class, a risk severity value (e.g., measured in energy units such as kinetic energy or modified kinetic energy, such that the risk severity value includes an estimated kinetic energy associated with avoiding and/or mitigating the risk, etc.), a risk probability value, (e.g., a value between 0 and 1 indicating the likelihood of the risk, etc.), a risk relevance value (e.g., a value between 0 and 1 indicating the importance of the risk given a current objective of the ego vehicle, etc.), a risk persistence value (e.g., scoring risks according to their appearing across multiple simulations in parallel and/or in multiple subsequent election cycles, etc.), a temporal component (e.g., time until the risk may occur within the simulation horizon), a spatial component (e.g., location where the risk is predicted to manifest), and/or any other risk information and/or parameters.

In examples of the individualized risk variation, for collision risks, risk values can include: impact velocity (e.g., relative velocity at predicted impact time, etc.), impact angle (e.g., a front, side, and/or rear impact classification, a numerical value, etc.), impact energy (e.g., kinetic energy transfer, etc.), an object softness factor (e.g., 1.0 for vehicles, 2.5 for pedestrians, 1.5 for cyclists), a minimum time to collision (e.g., seconds until impact if no preventative action taken), and/or any other suitable collision risk information.

In examples of the individualized risk variation, for conflict risks, parameters can include: conflict zone dimensions (e.g., overlapping area in square meters), conflict zone coordinates, time gap at conflict point (e.g., temporal separation between ego and other agent occupying the conflict zone), crossing angle (e.g., to differentiate perpendicular, merging, and/or head-on conflicts), conflict duration (e.g., time window during which both agents may occupy the same space, etc.) and/or any other suitable conflict risk information.

In examples of the individualized risk variation, for clearance risks, parameters can include: minimum lateral clearance (e.g., closest lateral distance in meters), minimum longitudinal clearance (e.g., following distance or headway in meters), clearance duration (e.g., time period of insufficient clearance), relative speed differential (e.g., speed difference affecting required clearance), clearance violation severity (e.g., percentage below an allowable threshold), and/or any other suitable clearance risk information.

In examples of the individualized risk variation, for infrastructure risks, parameters can include: curve radius (e.g., minimum turning radius in meters), maximum allowable speed (e.g., speed limit for curve negotiation), lane boundary type (e.g., solid line, dashed line, physical barrier), boundary crossing severity (e.g., minor encroachment vs. full departure), road surface condition factor (e.g., friction coefficient modifier), and/or any other suitable infrastructure risk information.

However, risks can include any other suitable variations of risk, determined through modeling, scoring, evaluation, analysis, and/or any other suitable processes.

The system 100 can include and/or interface with an ego vehicle (equivalently referred to herein as an autonomous vehicle, autonomous agent, ego agent, etc.) and a set of computing subsystems thereof (equivalently referred to herein as a set of computers) and/or processing subsystems (equivalently referred to herein as a set of processors), which function to implement any or all of the processes of the method. Additionally or alternatively, the system 100 can include and/or interface with one or more sets of sensors (e.g., onboard the ego agent, onboard a set of infrastructure devices, etc.), a simulation subsystem including a set of simulators (e.g., executable at one or more computing subsystems), a set of infrastructure devices, a teleoperator platform, a tracker, a positioning system, a guidance system, a communication interface, and/or any other components.

The system can optionally include or interface with a sensor suite, which functions to monitor vehicle state parameters and/or an environment of the vehicle to be used as inputs for vehicle control (e.g., autonomous vehicle control). The sensor suite can include: perception sensors (e.g., motion sensors, time of flight sensors, cameras, Radar, Lidar, etc.), environmental sensors (e.g., cameras, temperature, wind speed/direction, barometers, air flow meters), guidance sensors (e.g., Lidar, Radar, cameras, etc.), cameras (e.g., CCD, CMOS, multispectral, visual range, hyperspectral, stereoscopic, etc.), spatial sensors, internal sensors (e.g., accelerometers, magnetometer, gyroscopes, IMU, INS, temperature, voltage/current sensors, etc.), inertial sensors (e.g., IMU, accelerometers, magnetometer, gyroscopes, etc.), diagnostic sensors (e.g., cooling sensors such as: pressure, flow-rate, temperature, etc.; BMS sensors; tractor/trailer inter-connection sensors or passthrough monitoring, etc.), location sensors (e.g., GPS, GNSS, triangulation, trilateration, etc.), wheel encoders, proximity sensors, OBD-port, and/or any other suitable sensors. The computing system preferably receives sensor inputs from the sensor(s) of the sensor suite, but the inputs can additionally or alternatively include historical information associated with the ego agent (e.g., historical state estimates of the ego agent) and/or environmental agents (e.g., historical state estimates for the environmental agents), sensor inputs from sensor systems offboard the ego agent (e.g., onboard other ego agents or environmental agents, onboard a set of infrastructure devices and/or roadside units, etc.), environmental representation (e.g., determined based on current and/or historical sensor data), and/or any other inputs or information. However, the system can include any other suitable sensor suite.

The system can optionally include and/or interface with a vehicle control system including vehicle modules/components which function to effect vehicle motion based on the operational instructions (e.g., plans and/or trajectories) generated by one or more computing systems and/or controllers. Additionally or alternatively, the vehicle control system can include, interface with, and/or communicate with any or all of a set electronic modules of the agent, such as but not limited to, any or all of: component drivers, electronic control units (ECUs), telematic control units (TCUs), transmission control modules (TCMs), antilock braking system (ABS) control module, and/or any other suitable control subsystems and/or modules. In preferred variations, the vehicle control system includes, interfaces with, and/or implements a drive-by-wire system of the vehicle. Additionally or alternatively, the vehicle can be operated in accordance with the actuation of one or more mechanical components, and/or be otherwise implemented. However, the system can include or be used with any other suitable vehicle control system; or can be otherwise suitably implemented. For example, the system can be implemented in conjunction with the vehicle control system(s) and/or fallback controller as described in U.S. application Ser. No. 17/550,461, filed 14 Dec. 2021, which is incorporated herein in its entirety by this reference.

The computing system preferably functions to facilitate method execution. Additionally or alternatively, the computing system can function to process inputs from the sensor suite to determine a policy for each election cycle (e.g., with a frequency of about 10 Hz; 13 Hz, 15 Hz; etc.) of the autonomous vehicle, to be executed by the vehicle control system to facilitate autonomous operation via Block S500. However, the computing system can be otherwise configured.

The computing system can execute a set of models, which can include: an optional policy generator 104, a Multi-Policy Decision-making Model (MPDM) 101, a Risk Model (RM) 102, a discount model 108, and/or any other suitable models.

The multi-policy decision-making model 101 functions to simulate, select, and determine vehicle control policies for implementation by the vehicle. In variants, the MPDM model 101 can include the risk model 102 or can be separate from the risk model 102. The MPDM model 101 preferably includes a simulation engine 109 for performing policy simulation (e.g., S310), the risk model 102 for performing risk analysis (e.g., S320) and weighted risk profile discounting (e.g., S340), and the discount model 108 for performing discount profile determination. However, the MPDM model 101 can be otherwise configured.

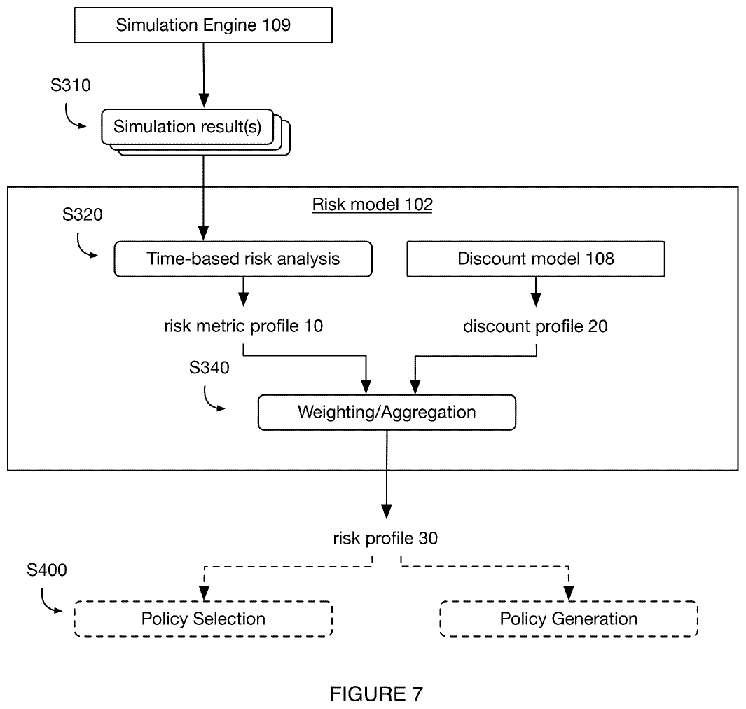

The risk model 102 functions to determine a weighted risk profile 30 associated with a scene (e.g., example shown in FIG. 7). Inputs to the risk model can include simulation results from policy rollouts (e.g., from S310 of an election cycle), risk data from multiple simulated policies, environmental representation data, sensor measurements, and/or any other suitable information. Outputs of the risk model can include a weighted risk profile (e.g., a weighted and/or aggregated risk, risk-to-agent mappings, temporal risk information, and/or prioritization data, etc.) and/or any other suitable information. In a variant, a risk model 102 can determine a risk profile 10 from simulation results and can weigh the risk profile 10 using a discount profile 20 to determine a weighted risk profile 30. For example, weighing the risk profile can include multiplying the discount profile and/or discretized values thereof to the corresponding (binned) values of the risk profile. In a first example, the discount profile determined via a lookup table. In a second example, the discount profile is determined as an output of a neural network. In a third example, parameters (e.g., slope, minimum time to stop, decay rate, etc.) defining a discount function (e.g., the discount profile) can be calculated based on vehicle intrinsics, vehicle kinematics, and environmental parameters. However, the discount profile can come from any other suitable source.

In a first variant, the risk model 102 can operate on outputs determined during policy simulation. In this variant, the risk model preferably aggregates control effort (e.g., and/or individual, identified risks, as in the individualized risk variation) across multiple different simulations (e.g., including simulations of policies that are elected to be implemented by the ego vehicle, etc.). In an example, for a risk profile for a candidate policy, control effort (e.g., associated with risk) is aggregated from multiple simulation cycles from a same election cycle, each including multiple simulations (e.g., each simulation representing different policies for the ego vehicle and/or environmental agents in the scene, etc.).

In a second variant, the risk model determines risk independently of simulation and/or simulation results determined therefrom. In this variant, a weighted risk profile can be determined for a scene based on sensor measurements, an environmental representation of the scene, and/or any other suitable information without relying on forward simulation data. However, the risk model can alternatively operate on any other suitable inputs. The risk model can output a risk profile 10, a weighted risk profile 30 (e.g., a weighted risk profile 10, etc.) and/or any other suitable information.

The risk model can be or can include: risk lookup tables, statistical techniques (e.g., based on historical severity and/or frequency of an accident for the specific element instance or the element class), Monte Carlo simulation, stress testing, Bayesian networks, logistic regression, decision trees, cox proportional hazards model, extreme value theory, Markov models, risk scoring models (e.g., attribute-based score assignment), Copula models, stochastic processes, and/or any other suitable models. The risk model can be deterministic, but can alternatively be probabilistic. The risk model is preferably numerical, but can alternatively be analytical. The risk model is preferably not a neural network, but can alternatively be a neural network.

The risk model 102 is preferably executed by the computing system 170 but can additionally or alternatively be implemented by any other suitable computing system or hardware configuration. However, the risk model 102 can be otherwise configured. The risk model can optionally include a discount model 108; however, the discount model 108 can alternatively be separate from the risk model. The risk model can include algorithms to perform risk analysis (e.g., time-based risk analyses), weighting, aggregation, and/or any other suitable operations (e.g., as described in at least: S310, S320, S330, and S340).

However, the risk model 102 can be otherwise configured.

The discount model 108 functions to determine a temporal weighting for risks at different points (i.e., discrete timesteps) in a planning horizon. The discount model preferably performs S330 but can additionally or alternatively perform any other suitable process. In variants, the discount model can be integrated with the risk model 102 or separate from the risk model 102. The discount model can include and/or implement one or more of: heuristic techniques (e.g., scoring based on qualitative features and/or quantitative values, etc.), model based risk estimation (e.g., in variants in which the discount profile is based on risk), lookup tables (e.g., where discount profiles and/or parameters thereof are predetermined and associated with particular attributes of a risk and/or scene), a neural network (e.g., trained to predict an optimal discount profile), statistical methods, decision trees, and/or any other suitable evaluation methods. In a first variant, the discount model is a trained neural network. In a second variant, the discount model is a physics-based analytical model that computes discount profiles based on vehicle dynamics and control envelope constraints (e.g., maximum braking effort, stopping distance calculations, response latency, etc.). In a third variant, the discount model is a lookup table (e.g., where discount profiles are predetermined and associated with certain risk types, environment types, vehicle kinematic states, and/or any other suitable system state. In a first example, the discount model outputs a set of individual point-in-time weights for use as a discount profile. In a second example, the discount model outputs a set of parameters (e.g., a decay rate, a minimum stopping time, etc.) defining a discount function for use as a discount profile.

However, the discount model 108 can be otherwise configured.

The models can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance values, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models (e.g., the risk model, discount model, etc.) can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, the computing system can include any other suitable set of models.

However, the system can include any other suitable elements.

### 4. Method

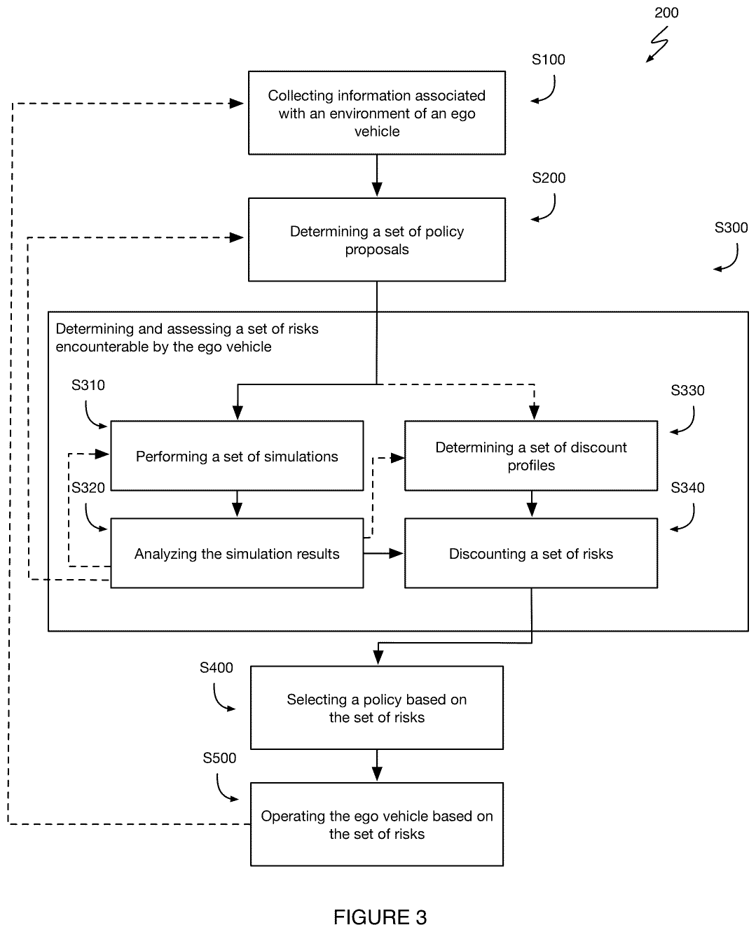

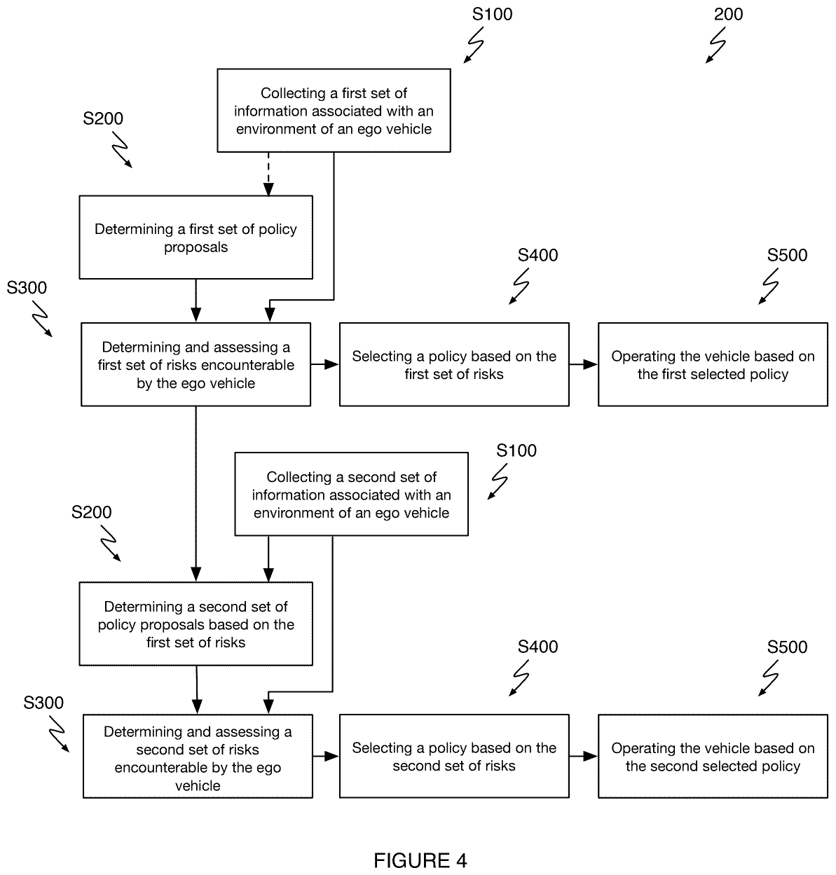

A method 200 for risk-aware policy assessment for an autonomous vehicle, an example of which is shown in FIG. 3, can include: collecting information associated with an environment of an ego vehicle S100; determining a set of policy proposals S200; determining and assessing a set of risks encounterable (e.g., potentially encountered in the future) by the ego vehicle S300; and/or any other suitable elements. Additionally or alternatively, the method can include any or all of: operating the ego vehicle based on the set of risks S500, performing a set of simulations S310, analyzing the simulation results S320, and/or any other processes. The method 200 can be performed with a system 100 as described above and/or any other suitable system. In variants, the method can include or be used in conjunction with the risk assessment method(s) and/or element(s) as described in U.S. application Ser. No. 18/538,312, filed 13 Dec. 2023, which is incorporated herein in its entirety by this reference. An example of the method 200 is shown in FIG. 4.

The method 200 preferably functions to accurately assess and optimally respond to potential risks that the ego vehicle may encounter in the future. Additionally, the method can determine (risk-aware) policies based on prior risk analysis (e.g., optionality and/or time-based risk analysis). The risks (equivalently referred to herein as hazards and/or hazardous events) encounterable by an autonomous vehicle preferably refer to potentially hazardous scenarios which are detectable by the autonomous vehicle, such as potentially hazardous events (e.g., collisions, potential collisions, etc.) that are detected based on data collected via the sensor suite vehicle and processed at prediction and/or planning subsystems.

The method 200 can optionally be configured to interface with a multi-policy decision-making process (e.g., multi-policy decision-making task block of a computer-readable medium; MPDM) of the ego agent and any associated components (e.g., computers, processors, software modules, etc.), but can additionally or alternatively interface with any other decision-making processes. In a preferred set of variations, for instance, a multi-policy decision-making model of a computing subsystem (e.g., onboard computing system) includes a simulator module (or similar machine or system) (e.g., simulator task block of a computer-readable medium) that functions to predict (e.g., estimate) the effects of future (i.e., steps forward in time) behavioral policies (operations or actions) implemented at the ego agent and optionally those at each of the set environmental agents (e.g., other vehicles in an environment of the ego agent) and/or objects (e.g., pedestrians) identified in an operating environment of the ego agent. The simulations can be based on a current state of each agent (e.g., the current hypotheses) and/or historical actions or historical behaviors of each of the agents derived from the historical data buffer (preferably including data up to a present moment). The simulations can provide data relating to interactions (e.g., relative positions, relative velocities, relative accelerations, etc.) between projected behavioral policies of each environmental agent and the one or more potential behavioral policies that may be executed by the autonomous vehicle. The data from the simulations can be used to determine (e.g., calculate) any number of values, which can individually and/or collectively function to assess any or all of: the potential impact of the ego agent on any or all of the environmental agents when executing a certain policy, the risk of executing a certain policy (e.g., collision risk), the extent to which executing a certain policy progresses the ego agent toward a certain goal, and/or determining any other values involved in selecting a policy for the ego agent to implement. The multi-policy decision-making process can additionally or alternatively include and/or interface with any other processes, such as, but not limited to, any or all of the processes described in: U.S. application Ser. No. 16/514,624, filed 17 Jul. 2019; and U.S. application Ser. No. 17/365,538, filed 1 Jul. 2021; each of which is incorporated in its entirety by this reference, or any other suitable processes performed in any suitable order.

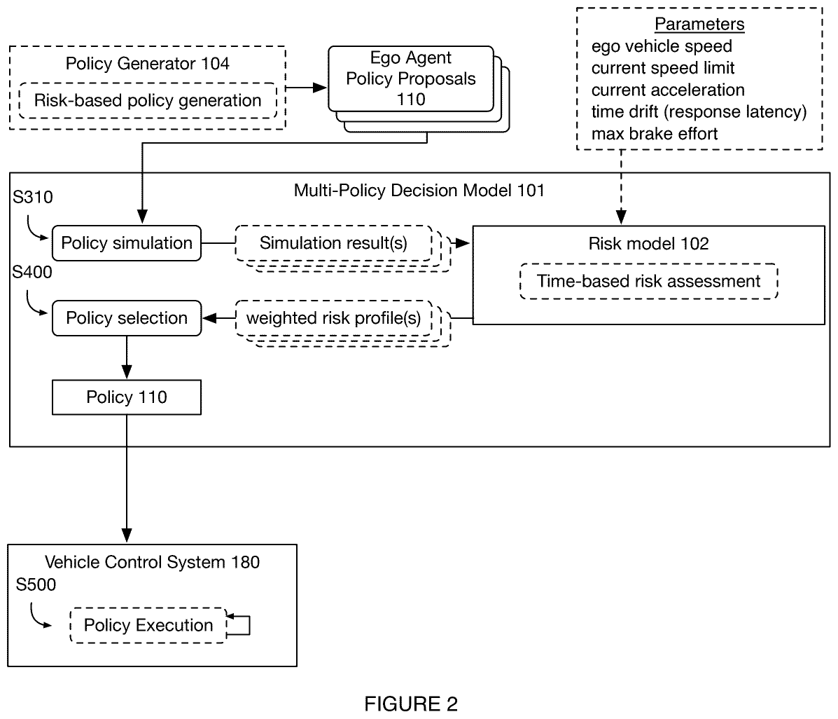

In a preferred set of variants, for instance, the method and/or simulation (and risk assessment) is performed for each of a set of policy proposals (a.k.a., policy candidates) under consideration by the autonomous vehicle (e.g., as determined by S200), where a risk value and/or weighted risk profile is generated for each policy proposal, where a particular policy is selected based on the value(s) and/or profile(s). Selecting this policy, for instance, can be based on any or all of: a time in the future at which a maximum risk is predicted to occur (e.g., how far in the future) in the policy, a total level of risk associated with the policy (e.g., integrating over a risk curve), a magnitude of the risk (e.g., magnitude of maximum point in weighted risk profile), an average risk, a median risk, and/or any other values. In some examples, for instance, a policy is selected based on both the value of the risk magnitude and the time in the future at which the risk is predicted to occur. Additionally or alternatively, the risk value(s) can dynamically inform which policy candidates are considered in future election cycles, and/or can be used to generate/refine risk-aware policies in future election cycles (e.g., an example is shown in FIG. 2). In some examples, for instance, at least a portion of the policies evaluated within an election cycle are determined based on the (environmental) risks and/or profiles produced in a prior (e.g., immediately preceding) election cycle. Additionally or alternatively, the method 200 can include and/or otherwise interface with any other decision-making processes and/or models of the computing system.

### 4.1 Method—Collecting Information Associated with an Environment of an Ego Vehicle S100

The method can include collecting information associated with an environment of an ego vehicle S100, which functions to receive information with which to assess the ego vehicle's environment and inform the performance of any or all of the remaining processes of the method 200.

S100 is preferably performed continuously (e.g., at a predetermined frequency, at irregular intervals, etc.) throughout operation of the ego agent, but can additionally or alternatively be performed: according to (e.g., at each initiation of, during each of, etc.) a cycle associated with the ego agent, such as any or all of: an election cycle (e.g., 5 Hz, 10 Hz, etc.; between 5-20 Hz cycle, etc.) associated with the ego agent (e.g., in which the ego agent selects a new policy), a perception cycle associated with the ego agent, a planner cycle (e.g., 30 Hz, between 20-40 Hz, occurring more frequently than the election cycle, etc.) associated with the ego agent; in response to a trigger (e.g., a request, an initiation of a new cycle, etc.); and/or at any other times during the method 100.

The inputs preferably include sensor inputs received from a sensor suite (e.g., cameras, Lidars, Radars, motion sensors [e.g., accelerometers, gyroscopes, etc.], outputs of an OBD-port, etc.], location sensors [e.g., GPS sensor], etc.) onboard the ego agent, but can additionally or alternatively include historical information associated with the ego agent (e.g., historical state estimates of the ego agent) and/or environmental agents (e.g., historical state estimates for the environmental agents), sensor inputs from sensor systems offboard the ego agent (e.g., onboard other ego agents or environmental agents, onboard a set of infrastructure devices and/or roadside units, etc.), information and/or any other inputs.

The inputs preferably include information which characterizes the environment of the ego agent, which can include: other objects (e.g., vehicles [equivalently referred to herein as environmental agents], pedestrians, stationary objects, etc.) proximal to the ego agent (e.g., within field-of-view of its sensors, within a predetermined distance, etc.), equivalently referred to herein as environmental agents; environmental features of the ego agent's surroundings (e.g., to be referenced in a map, to locate the ego agent, etc.); and/or any other information. In some variations, for instance, the set of inputs includes information (e.g., from sensors onboard the ego agent, from sensors in an environment of the ego agent, from sensors onboard the objects, etc.) that characterizes any or all of: the location, type/class (e.g., vehicle vs. pedestrian, etc.), and/or motion of environmental objects being tracked by the system 200, where environmental objects can include static objects (e.g., parked or otherwise non-moving vehicles, stationary pedestrians, etc.), dynamic objects (e.g., moving vehicles, walking or running pedestrians, bikers, etc.), or any other objects or combinations of objects. Additionally or alternatively, the set of inputs can include information that characterizes (e.g., locates, identifies, etc.) features of the road and/or other landmarks/infrastructure (e.g., where lane lines are, where the edges of the road are, where traffic signals are and which type they are, where agents are relative to these landmarks, etc.), such that the ego agent can locate itself within its environment (e.g., in order to reference a map), and/or any other information.

The inputs further preferably include information associated with the ego agent, which herein refers to the vehicle being operated during the method. This can include information which characterizes the location of the ego agent (e.g., relative to the world, relative to one or more maps, relative to other objects, etc.), motion (e.g., speed, acceleration, etc.) of the ego agent, orientation of the ego agent (e.g., heading angle), a performance and/or health of the ego agent and any of its subsystems (e.g., health of sensors, health of computing system, etc.), and/or any other information.

Any or all of this information can additionally or alternatively be determined for environmental objects.

Additionally or alternatively, S100 can include any other processes and/or involve the collection of any other suitable information.

In a preferred set of variations, S100 includes collecting sensor data which is used to perform the simulations described in S310.

### 4.2 Method—Determining a Set of Policy Proposals S200

The method 200 can include determining a set of policy proposals S200 which can be simulated and/or assessed for risk in S300 (e.g., which may be used to select a policy for autonomous operation via S400 at each election cycle). Additionally, S200 can incorporate (environmental) risk awareness from a prior election cycle (and/or prior instance of S300) to facilitate refinement around risk factors most impacting policy selection (i.e., based on impact on the reward functions in S500) and/or based on temporal optionality. For example, S200 can propagate risk awareness (e.g., temporal risk awareness) across multiple election intervals, thus enabling a degree of refinement across longer time scales, though each individual election can be based on deterministic simulation within a single election cycle (e.g., where compute time is bounded within an election interval). Additionally, policy proposals in S200 can be determined based on decision criteria and reward functions, which may facilitate optimization around the proposals most likely to be favorably evaluated in S500 (e.g., in view of current environmental risks and/or the current weighted risk profile).

The set of policy proposals can be determined based on a set of inputs (e.g., as determined by S100), which can include: the vehicle state, an environmental representation (e.g., a set of agents in the environment), route information (and/or a reward function associated therewith), policy selection criteria (e.g., reward function and/or cost function evaluated in S500, etc.), prior environmental risk (e.g., environmental weighted risk profiles from a prior risk analysis; such as for each agent in a prior representation and/or prior risk analysis), and/or any other suitable set of inputs.

In a first set of variants, a first set of policy proposals can be predetermined and/or predefined for a particular driving context/region (e.g., highway; multi-lane roadway; etc.), such as according to a set of heuristics and/or predefined rules (e.g., a lookup table, etc.). For example, a set of fallback policies (e.g., emergency stop; evasive left; evasive right; etc.) can be considered as policy proposals at each election cycle. Additionally or alternatively, the set of fallback policies can be refined in S200 based on weighted risk profiles in the environment. For instance, based on the weighted risk profiles, S200 can propose exactly one evasive turn as a (fallback) policy proposal: either an evasive left or an evasive right. As a second example, a set of ‘ego-relative’ policies (e.g., coast in lane; shift and stop at shoulder; etc.) can be proposed at each election cycle, independently of any agents in the environment. However, another subset of predefined policies can be proposed in S200 and/or every fallback policy may be proposed at each election cycle.

In a second set of variants, nonexclusive with the first, a second set of (risk-aware) policy proposals can be determined based on the environmental representation and/or environmental risks associated therewith. For example, policies can be constructed/generated as a combination of policy elements 111 (i.e., control laws, constraints, actions, etc.) which address agents and/or risks in the environment (e.g., as assessed in a prior iteration of S300). Policy elements can address individual agents, multiple agents (e.g., same or different type; all agents of a particular type; a series of parked cars), a single risk element, multiple risk elements, and/or any other suitable policy element(s). For instance, a first policy may direct the ego agent to cross a road centerline to navigate around a parked car along the curb of a narrow road, while a second policy may navigate past four cars parked along the curb (e.g., up to a point where there is sufficient clearance for opposing traffic flow).

The policies can be constructed from policy elements in any suitable combinations and/or permutations of elements. In such variants, policy elements can be selected by an element selector 103. Additionally, policies can be refined or filtered according to any suitable set of rules, heuristics, predetermined (deterministic) constraints (i.e., pertaining to roadway rules; mutual exclusivity; physics; etc.), and/or can be otherwise filtered. As an example, it may be invalid to combine a policy of changing lanes to the left and changing lanes to the right, since these policies are mutually exclusive. Likewise, it may be invalid to follow a first agent while passing a second agent. Thus, the policies are preferably constructed from (all) valid combinations of policy elements (i.e., control laws).

The second set of (risk-aware) policy proposals preferably satisfy the constraints (e.g., predefined, deterministic). Additionally, this set of proposals can be further refined to propose policies which are less risk producing (e.g., lower risk probability) and, secondarily, produce greater rewards. The policy generator (e.g., alternatively referred to as a “policy generator model” or “PGM”, etc.) can output this fuzzy optimization given the set of inputs and/or a cost function (e.g., which can be the same as may be evaluated in S500, or different), via the policy generator.

As an example, the policy generator 104 can be a classically programmed heuristic optimization which selects the best N policy proposals satisfying a set of optimization constraints (e.g., below a predetermined risk threshold). As a second example, the policy generator can generate a set of policy proposals (e.g., control laws for a particular path) by any one or more of: regression, neural networks, ensemble methods, optimization methods, heuristics, equations, Bayesian methods, support vectors, statistical methods (e.g., based on risk probability), fuzzy logic, comparison methods, deterministics, genetic programs, and/or any other suitable methods or model elements.

However, risk-aware policies can be otherwise determined.

In a third set of variants, S200 can include a combination of the first and second variants (e.g., where the first set of policy proposals and the second set of risk-aware policy proposals are output by S200 for simulation and risk assessment in S300).

However, policy proposals can be otherwise determined and/or any other suitable set of policies can be considered, simulated, and/or assessed in S300.

### 4.3 Method—Determining and Assessing a Set of Risks Encounterable by the Ego Vehicle S300

The method includes determining and assessing a set of risks encounterable by the ego vehicle S300, which functions to perform any or all of: evaluating general risk (e.g., control effort expended in a simulation(s) of different candidate policy options, etc.), evaluating individualized risk, detecting the potential hazards that the ego vehicle may encounter in the future, determining whether or not (and/or when) these potential hazards pose a current or future risk, and determining whether or not the potential hazards could be avoided (e.g., by the ego vehicle, by other vehicles or entities in an environment of the ego vehicle, etc.). S300 further preferably functions to inform how a vehicle is operated in S500. Additionally or alternatively, S300 can perform any other suitable functions. S300 is preferably performed in response to and based on the information received in S100 and/or S200, but can additionally or alternatively be performed at any other suitable times and/or based on any suitable information.

S300 preferably includes performing a set of simulations S310 (e.g., as shown in FIG. 3), which functions to enable risks which could occur in the future to be detected and further characterized (e.g., in S320). S310 is preferably performed by a simulation engine 109 of an MPDM model 101 but can additionally or alternatively be performed by any other suitable system component. The set of simulations preferably includes forward simulations, which examine future scenarios (based on forward stepping in time) for the ego vehicle and objects (e.g., other vehicles, pedestrians, etc.) in its environment, such as in an event that the ego vehicle (and/or other vehicles) performs a certain policy (e.g., behavior, action, etc.). In variants, different simulations of the set of simulations can include different proposed policies, such that the impacts of election of different policies can be predicted (e.g., via risk values, a cost function, etc.). In variants, the set of simulations can include multiple simulations for each proposed policy (e.g., wherein between such multiple simulations, the policies assigned to other agents in the scene [representing the objectives of other agents] differ, etc.). Additionally or alternatively, the simulations can be otherwise suitably performed.

In a preferred set of variations, any or all simulations are performed within (e.g., during, as part of, etc.) a multi-policy decision-making process (e.g., as described above, as implemented during a planning/election cycle of the ego agent, etc.), such any or all of those described in U.S. application Ser. No. 16/514,624, filed 17 Jul. 2019, and/or U.S. application Ser. No. 17/365,538, filed 1 Jul. 2021, each of which is incorporated herein in its entirety by this reference. Alternatively, the simulations can be performed in accordance with a different decision-making process, performed absent of and/or asynchronously with a multi-policy decision-making process (e.g., during a trajectory generation and/or trajectory modification phase, during a path planning process, etc.), and/or at any other time(s).

In a set of examples, for instance, a set of simulations (e.g., including each simulation type) is performed for each policy proposal determined at S200.

The set of simulations preferably includes multiple types of simulations, wherein the multiple types of simulations function to collectively provide accurate, robust assessments of risks and/or features of the risks (e.g., likelihood, characterization, etc.) which may occur in the future. The multiple simulation types can be simulated: in parallel, in series, and/or any combination. Alternatively, simulations of a single type and/or any other types of simulations can be performed in S310. For example, the set of simulations can include any type(s) of simulations as disclosed in U.S. application Ser. No. 16/514,624, filed 17 Jul. 2019; and U.S. application Ser. No. 17/365,538, filed 1 Jul. 2021; each of which is incorporated in its entirety by this reference. Additionally or alternatively, the set of simulations can include any other simulations and/or types of simulations.

As an example, the simulations can be run on a per-policy basis for samples selected from a probability distribution for the environmental representation of the ego vehicle. Per-policy world samples can be simulated in parallel, and the sample rollouts can be analyzed (e.g., in parallel and/or in aggregate) in S320 in order to determine a policy election.

As a second example, the simulations can include the set of simulation rollouts determined by a Multi-Policy Decision Making process and/or module.

However, S310 can include any other suitable set of simulations.

S300 further preferably includes analyzing the simulation results S320, which functions to detect, characterize, and/or quantify any or all of the risks encounterable by the vehicle and/or other agents in an environment of the vehicle (e.g., other vehicles, pedestrians, cyclists, etc.). Additionally, S320 can analyze the simulation results (a.k.a., sample rollouts) to perform time-based risk evaluation. However, S320 can include any other suitable set of elements. S320 can be performed during S310 (e.g., storing a control effort at each timestep at each rollout simulated by MPDM, etc.), after S310, and/or at any other suitable time. S320 preferably includes generating a risk profile 10 but can additionally or alternatively generate any other suitable information. S320 is preferably performed by the risk model (e.g., and/or algorithms thereof) but can alternatively be performed by any other suitable system component.

In S320, the computing system (and/or a risk model 102 thereof) preferably determines a set of values and/or scores (e.g., a risk profile 10) in association with each simulation (per policy). More preferably, risk values are computed by the risk model 102 for each per-policy sample rollout which can be used in decision-making (e.g., policy selection for a current election cycle; risk-aware policy determination in a subsequent election cycle; etc.) of the ego vehicle in S500, but can additionally or alternative be used to trigger further analyses (e.g., reward analyses), and/or otherwise be suitably used.

In the general risk variation, the risk profile 10 can include general risk (e.g., as a proxy for control effort, uncertainty, and/or any other suitable parameters) for the overall scene at different timesteps. In this variation, values of the risk profile can include risk severity values (e.g., energy expended by the vehicle at each timestep, damage to the vehicle at each timestep, etc.), risk probability, risk type (e.g., a type of control effort expended, etc.), uncertainty (e.g., confidence associated with identification of agents in the scene, confidence associated with the determinations of agent behavior for other agents in the scene, confidence associated with an accuracy of the simulation results, etc.). In a preferred variant, each timestep is associated with risk severity values that represent control effort exerted by the vehicle and/or components thereof over the simulations at the timestep.

In a first variant of the general risk variation, values of each timestep of the risk profile correspond to an aggregated risk value from each of a set of multiple simulations at that timestep. For example, a control effort (risk severity value) exerted by the ego vehicle and/or agents in the scene at an Nth timestep for each of a set of Y simulations can be aggregated (e.g., averaged, etc.), and the aggregated value can be used for the risk profile. In a second variant of the general risk variation, values of each timestep can correspond to a distribution of timesteps within each of the Y simulations (e.g., can be sampled from a normal distribution of timesteps with a central value being the Nth timestep). In examples, the risk values are “binned” into discrete timesteps of the risk profile. However, risk values can be otherwise aggregated in the general risk variation.

In the individualized risk variation, non-exclusive with the general risk variant, the risk profile 10 can include, for a single risk or multiple risks: risk class (e.g., type), a risk severity value (e.g., measured in energy units such as kinetic energy or modified kinetic energy, such that the risk severity value includes an estimated kinetic energy associated with avoiding and/or mitigating the risk, etc.), a risk probability value, (e.g., a value between 0 and 1 indicating the likelihood of the risk, etc.), a risk relevance value (e.g., a value between 0 and 1 indicating the importance of the risk given a current objective of the ego vehicle, etc.), a risk persistence value (e.g., scoring risks according to their appearing across multiple simulations in parallel and/or in multiple subsequent election cycles, etc.), a temporal component (e.g., time until the risk may occur within the simulation horizon), a spatial component (e.g., location where the risk is predicted to manifest), and/or any other risk information and/or parameters.

In a preferred set of examples of the individualized variation, for instance, in an event that a potential hazardous event is detected, the amount of work required by each of the involved objects (e.g., environmental agents, ego vehicle, etc.) to avoid the hazardous event is calculated. Based on these work metrics, a level of braking required to perform this amount of work can be calculated for each of the involved vehicles (e.g., cars, bikes, etc.) and compared with one or more braking thresholds (e.g., braking force, braking magnitude, etc.) to determine if and/or to what extent it would be possible for the vehicles to stop and avoid the event (e.g., wherein if the level of braking is below a predetermined threshold it is determined that the vehicle could stop, wherein if the level of braking is above a predetermined threshold it is determined that the vehicle could not stop, etc.). In an example, a predetermined braking threshold can be 0.1 G, 0.2 G, 0.3 G, 0.5 G, 0.7 G, 1 G, within an open or closed range bounded by the aforementioned values, and/or any other suitable braking threshold. Additional or alternative to a braking level, any other values can be calculated, such as, but not limited to: a braking rate, a braking distance, a stopping distance, an acceleration and/or deceleration rate, a response time (e.g., to be compared with average human response times), the effect of changing heading (e.g., whether or not it would be possible to swerve to avoid an event), and/or any other values. Any of the aforementioned parameters (e.g., work metrics, energy metrics, braking values, etc.) can be aggregated and/or combined for use as a single variable or multi-variate risk severity value.

The risk profile 10 (e.g., of the risk profile in the general risk and/or individualized risk variations, etc.) can include risk severity values, risk probability values, risk type values, and/or any other suitable information relating simulations to risk.

Risk severity values (e.g., of the risk profile in the general risk and/or individualized risk variations, etc.) is preferably determined based on an energy metric, such as a kinetic energy and/or a modified (e.g., weighted, scaled, etc.) version of kinetic energy (e.g., derivative of velocity, velocity-squared, velocity-squared multiplied by a scaling factor, velocity-squared multiplied by mass and/or a scaling factor, kinetic energy without mass, etc.), where the energy metric represents—such as in the event of collision—the energy produced by the impact of the collision. In some variations, for instance, the risk severity value includes any calculated kinetic energy metrics aggregated with any energy metrics occurring in the scenario. In some examples, for instance, the simulation can show how if the ego vehicle engages in an overly conservative behavior immediately (e.g., stops immediately because a potential collision may occur), it might actually increase the overall total energy of the system (e.g., due to the amount the ego vehicle would have to brake, due to the amount of work other vehicles would have to spend in stopping because of the ego vehicle stopping, etc.) more than a potential hazardous event (e.g., ego vehicle hitting a curb). In a preferred set of variations, risk severity can be detected and/or characterized through the calculation of a set of work and/or energy metrics. In this variant, work metrics can represent the severity/magnitude of harm of a risk and/or energy metrics can represent the effort (e.g., expended by the ego vehicle and/or agents in the scene, etc.) exerted in the scene (e.g., at the time of the risk, as in the generalized variant; over a time window before and/or during the risk, to prevent such a risk event from occurring, as in the individualized risk variation, etc.). In embodiments, energy metrics can include work, force multiplied by displacement, modified work, scaled and/or weighted work, relative work, and/or any other suitable type of energy metric.

The work metrics preferably have the same units as the energy metrics (e.g., as described above), such that the work and energy metrics can be any or all of: aggregated, compared, and/or otherwise used. Based on these calculations of work, other values—such as those related to control commands of vehicles and/or temporal values—can be calculated and compared with thresholds (e.g., predetermined thresholds, class-label-specific thresholds, etc.) in order to determine how feasible it would be for the identified event to be avoided and/or how much time/distance the vehicle can traverse while avoidance remains feasible. Additionally or alternatively, any other features or information can be used to scale the energy metric, such as, but not limited to: a type of predicted impact, a location of a predicted impact (e.g., rear-end collision, head-on collision, etc.), and/or any other suitable features.

Risk probability values (e.g., of the risk profile in the general risk and/or individualized risk variations, etc.) can be determined from: agent policy probabilities (e.g., probability that an agent will execute a particular behavior), event occurrence probabilities (e.g., probability of collision given agent behaviors), track confidence measures (e.g., based on object tracking uncertainty), and/or any other suitable probability assessment.

Risk type values (e.g., of the individualized risk variation or the generalized risk variation) can be determined based on a type of effort expended (e.g., braking, swerving, accelerating, etc.), based on a detected scenario type which occurs in a simulation (e.g., a collision, a near-miss of a collision, a collision involving a fatality vs. injury vs. property damage, property damage, violation of traffic rules, etc.) and/or any other suitable information relating to a risk type.

The values of the risk profile 10 (e.g., in the general risk and/or individualized risk variations) can be exclusively ego vehicle-specific (e.g., can consider future states of the ego vehicle), exclusively agent-specific (e.g., can consider future states of other agents in the scene), or can combine values determined for the ego vehicle and the agents in the scene.

However, the risk profile 10 can include any other suitable types of information.

Risk profiles can be associated with any combination(s) of individual policies and/or a subset of policy elements and control laws thereof, one or more agents within the environment, and/or any other suitable environmental risks. Alternatively, subsequent iteration(s) of S200 can directly utilize the risk assessments of S300 to facilitate risk-aware policy determinations, and/or risks can be otherwise assessed/processed.

In a first variant, a risk profile 10 is agent-agnostic (e.g., as in the general risk variation; in which the weighted risk profile includes values relating to overall risk). In this variant, the weighted risk profile can be a scene-specific risk profile in an MPDM cycle configured to select policies that minimize overall risk.

In a second variant, a risk profile 10 is specific to a particular agent in the scene (e.g., the ego agent, an agent separate from the vehicle, etc.; as in the individualized risk variation). In this variant, the risk profile can include risks of different types, a single risk, a single risk type, and/or any other suitable information about risk associated with the agent. In an example, S320 includes determining multiple weighted risk profiles, each associated with a different agent in the scene and optionally with a set of weights representing likelihood of the agent's existence and/or probability of the agent performing a particular behavior that causes the risk (e.g., turning left into the ego vehicle's lane instead of going straight, etc.).

In a third variant, a risk profile is behavior-specific (e.g., specific to an action candidate performable by another agent in the scene; as in the individualized risk variation). In this variant, the weighted risk profile represents risk(s) associated with the other agent performing a particular action. However, the risk profile can otherwise be specific or non-specific to risks, behavior, agents, and/or any other suitable entity.

The risk profile 10 preferably includes discrete risk values at each timestep in a time series (e.g., corresponding to each frame of the rollout[s]) but can alternatively be or include a continuous function over a temporal domain, a single aggregated value across a time horizon (e.g., a planning horizon, etc.), and/or any other suitable temporal representation. In a specific example, a risk profile includes a set of timesteps in a planning horizon and a set of risk values associated with each of a subset of the timesteps. For example, if a simulated risk is estimated to occur in X seconds, the timestep(s) associated with X seconds from a current timestep can include risk values associated with the simulated timestep. If there exists a probability distribution for the time at which the simulated risk may occur, risk values associated with the risk can be spread over multiple timesteps, each associated with a timestep-specific probability.

As an example, the S320 can include computing risk profiles 10 and/or risk values thereof on a per-agent basis relative to a vehicle control envelope (e.g., as a function of physical limitations of the vehicle, such as the maximum acceleration longitudinally and/or laterally at a particular speed and/or in view of environmental factors, etc.). In preferred variations, the risk values determined in S320 can inform the operation of the vehicle in S500 (e.g., selection of highest reward and/or lowest cost policy, etc.). Additionally, risk values can be used as an input for subsequent iterations of S200 (e.g., for a subsequent election cycle), which can be used for risk-aware policy generation (and/or candidate policy determinations) in subsequent election cycles. Additionally, risk values can be binned across rollouts to classify risk timing and/or probability of aggregates. For instance, a risk severity score/cost can be computed for an individual per-policy sample rollout (e.g., the sample rollout having some probability; as sampled from a probability distribution), and the cost and/or potential risks can optionally be classified/binned to determine aggregate values, such as a potential risk event probability under a particular policy. However, simulation and/or risk analyses can be otherwise used.

Accordingly, the risk values evaluated for each (per policy) rollout state yield risk estimation as a function of time for: individual risk values, aggregated risk values (e.g., for each policy proposal; for each rollout; relative to a single agent in the environment; relative to all agents in the environment; etc.), an individual policy proposal, an individual rollout, an individual agent in the environment, and/or any other suitable temporal risk evaluations.

In variants, the risk values (e.g., risk values, weighted risk values) can be stored in association with timesteps using stable binning techniques (e.g., to reduce sensitivity to floating point computational noise). In such variants, stable binning can include: defining reference risk value values, establishing tolerance margins around each reference value (e.g., ±5% of the reference value), and assigning risk values within each tolerance band to the corresponding reference value. Stable binning can prevent policy selection from oscillating between options due to small numerical differences in successive risk calculations that may arise from computational precision limitations. In examples, the stable binning parameters can be predetermined based on the expected precision requirements for policy differentiation; can be dynamically adjusted based on the computational environment and/or the magnitude of risk values being processed; and/or can otherwise be determined. In an example, S320 includes applying stable binning to control effort to generate the risk profile. In another example, S340 includes applying stable binning to the weighted risk values to generate the weighted risk profile.

However, analyzing the simulation results S320 can be otherwise performed.

Determining a set of discount profiles S330 functions to quantify the relevance of risks at future timesteps to a present decision-making cycle (e.g., policy election cycle, etc.). Determining a set of discount profiles is preferably performed after S320 (e.g., such that the risk profiles and/or values thereof can be used as inputs to S330) but can alternatively be performed before S330 and/or at any other suitable time (e.g., in variants in which a discount profile is independent of risks in the scene, etc.). S330 is preferably performed iteratively (e.g., dynamically, during successive cycles of MPDM). The discount profile can be dynamically updated during simulation rollouts based on changing ego vehicle state, evolving environmental conditions, and/or updated weighted risk profiles.

S330 is preferably performed by a discount model 108 (e.g., a discount model of the risk model 102, a discount model separate from the risk model 102), but can alternatively be performed by any other suitable system component. In variants, the discount model can be integrated with the risk model 102 or separate from the risk model 102. The discount model can include and/or implement one or more of: heuristic techniques (e.g., scoring based on qualitative features and/or quantitative values, etc.), model based risk estimation (e.g., in variants in which the discount profile is based on risk), lookup tables (e.g., where discount profiles and/or values thereof are predetermined and associated with particular attributes of a risk and/or scene), a neural network (e.g., trained to predict an optimal discount profile), statistical methods, decision trees, and/or any other suitable evaluation methods. In a first variant, the discount model is a trained neural network. In a second variant, the discount model is a physics-based analytical model that computes discount weights based on vehicle dynamics and control envelope constraints (e.g., maximum braking effort, stopping distance calculations, response latency, etc.). In a third variant, the discount model is a lookup table (e.g., where discount profiles are predetermined and associated with certain risk types, environment types, vehicle kinematic states, and/or any other suitable system state.

S330 can include determining a discount profile based on ego vehicle kinematics (e.g., speed, acceleration, etc.), agent kinematics (e.g., speed of an agent which is the source of the risk), a current speed limit, a time drift (response latency), a maximum allowable brake effort, road conditions, tire state (e.g., inflation state, etc.), temporal response optionality, a timestep of a risk, a severity of a risk, a probability/likelihood of a risk, agent/object softness (e.g., produced through a classification of the object with the ego vehicle's perception subsystem 107), agent/object human-ness (e.g., pedestrian, vehicle with a pedestrian, biker, number of anticipated humans involved, etc.), a probability/likelihood of a behavior performed by another agent, and/or any other suitable information. The time drift parameter can account for system latency between decision-making and vehicle response, and can be 0.1 seconds, 0.5 seconds, 1 second, 2 seconds, 5 seconds, within an open or closed range bounded by the aforementioned values, and/or any other suitable value. In the individualized risk variation, the discount profile can be determined as a function of multiple temporal parameters, including: time to potential risk event, distance to potential risk event, required response effort magnitude, and/or any other suitable temporal factors. In examples, the discount profile can weight these factors individually or in combination to produce a composite discount profile and/or parameters defining the discount profile (e.g., slope of regions of the discount profile, length of regions of the discount profile, etc.).

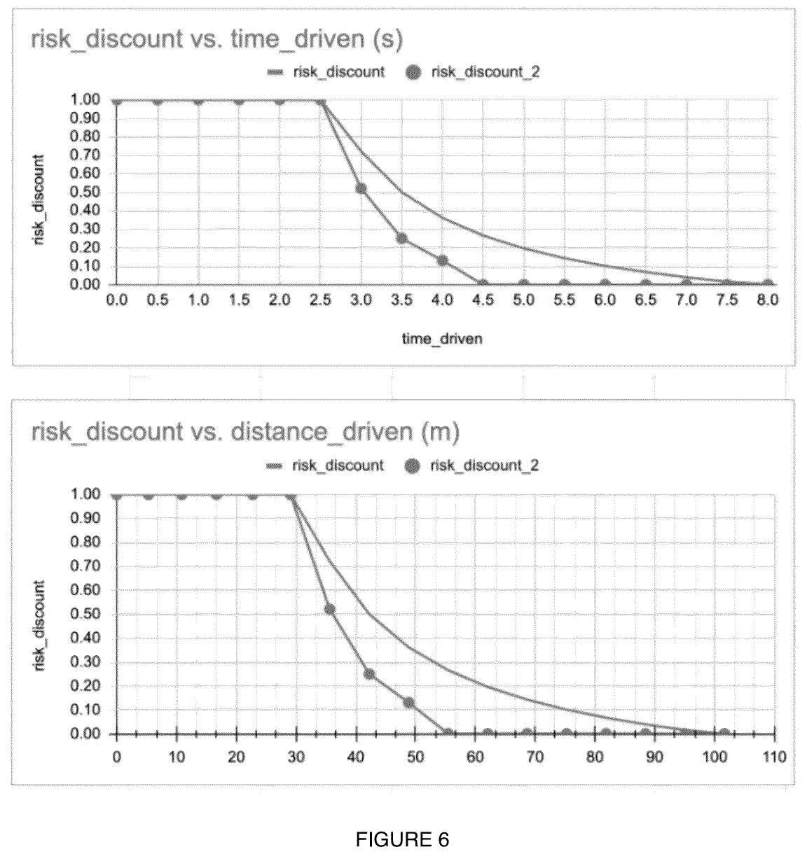

The discount profile preferably includes discount weights over a time horizon but can additionally or alternatively include discount weights over a distance horizon (e.g., example shown in FIG. 6, etc.). In preferred variants, the discount profile and/or weights thereof can include temporal response optionality (e.g., for individual risk values on a per-rollout basis; which may be nonlinear), which functions to weight risks by response urgency and/or required intervention effort. For instance, some risk scenarios and/or values associated with events and/or agent interactions in the distant future (e.g., ten seconds in the future; beyond the simulation window; etc.) may be weighted to zero and neglected, since the ego vehicle has remaining time to further analyze these scenarios and retains the option respond in advance of potential risk(s).

In a first variant (e.g., the general risk variation), a discount profile 20 is specific to the overall scene. In this variant, the discount profile can be based on ego vehicle intrinsics (e.g., vehicle kinematics, vehicle limitations, vehicle component wear state, etc.), context (e.g., speed limit; environment type, such as “driveway” or “highway”), uncertainty (e.g., uncertainty associated with agent identifications, estimations of behaviors, and/or any other suitable values, etc.) and/or any other suitable information.

In a second variant, a discount profile 20 is specific to a particular agent in the scene (e.g., an agent separate from the vehicle; as in the individualized risk variation). In this variant, the discount profile can be based on the ability of the agent to avoid a risk (e.g., a stopping energy associated with avoiding the risk, a speed of the agent, etc.), an agent type, a risk type, and/or any other suitable information. In an example, S320 includes determining multiple discount profiles, each associated with a different agent in the scene. In a specific example, during an MPDM simulation cycle, a stopping effort of another agent associated with the risk is calculated and used to determine the discount profile. Optionally, a discount profile can include a set of weights representing likelihood of the agent's existence and/or probability of the agent performing a particular behavior that causes the risk (e.g., turning left into the ego vehicle's lane instead of going straight, etc.). In a specific example, the probability of an agent performing a particular behavior can be derived from layers of a model-based vehicle controller outputs, such as SoftMax layers that provide probability distributions across potential agent behavior (e.g., policies).

In a third variant, a discount profile 20 is agent-agnostic. In an example of this variant, the discount profile is based exclusively on information relating to the ego vehicle (e.g., the ego vehicle kinematics, etc.). In an example of this variant, S330 applies a uniform discount profile across all agents in the scene based solely on the ego vehicle's stopping capabilities and vehicle control envelope.

In a fourth variant, a discount profile is behavior-specific (e.g., specific to a candidate behavior policy candidate performable by another agent in the scene; as in the individualized risk variant). In this variant, the discount profile represents discounts a risk(s) associated with the other agent performing a particular behavior. In this variant, the discount profile can incorporate risk probability assessments, where discount profiles (e.g., and/or weights thereof) are adjusted based on the probability/likelihood of risk events occurring. Low-probability risks may receive additional temporal discounting beyond that applied based purely on temporal optionality, while high-probability risks may receive reduced temporal discounting to ensure appropriate response readiness. Such probability-adjusted discount profiles can enable the system to balance response preparedness against computational efficiency and passenger comfort.

In a fourth variant, a discount profile is specific to longitudinal policy determination and/or lateral policy determination (e.g., in variants in which longitudinal policies, such as speeding up, following, and slowing down; and lateral policies, such as switching lanes, pulling over, and turning; are elected separately).

However, the discount profile can otherwise be specific or non-specific to risks, behavior, agent, and/or any other suitable entity.

The discount profile preferably comprises a monotonically decreasing parameter (e.g., a function, a set of discrete values, etc.) over time, where discount weights approach unity (full weighting) for temporally proximate risks and approach zero (minimal weighting) for temporally distant risks. The discount profile can be or include: a step function with discrete threshold transitions, a continuous exponential decay function, a piecewise linear function, a sigmoid function, and/or any other suitable mathematical representation. The temporal boundaries and decay characteristics of the discount profile are preferably determined based on the ego vehicle's current state and control capabilities. In an example, the discount profile is flat (constant) at a full weight (e.g., a weight of 1) over a first temporal region between a present time and a future time. In this example, the future time is a minimum stopping time (e.g., time it takes to fully stop the vehicle from its current speed), but can optionally additionally incorporate a set of delays and/or error thresholds. For a second temporal region after the first temporal region, the discount profile can be linearly decreasing, exponentially decaying, or following any other suitable mathematical decay pattern until reaching a minimum discount value (e.g., zero or near-zero weighting). The transition between the first and second temporal regions can be abrupt (step-wise), smooth (continuous derivative), or graduated (finite slope transition), depending on the desired balance between computational efficiency and decision smoothness. Additionally or alternatively, the discount profile can include a third temporal region at extended time horizons where discount weights remain at the minimum value, effectively ignoring risks beyond the vehicle's practical response planning horizon. However, the discount profile 20 can have any other suitable shape.

In variants, S330 includes determining additional discount weights based on other (e.g., non-temporal) factors. In such variants, the discount profile can include the additional discount weights or can be separate from the additional discount weights. Examples of such weights include the probability or likelihood of the other agent performing a behavior associated with the risk (e.g., at a present timestep and/or a future timestep), a type of the other agent, kinematics of the other agent, probability or likelihood of the risk occurring, and/or any other suitable information.

However, determining a set of discount profiles can be otherwise determined.

Discounting a set of risks S340 functions to focus MPDM policy evaluation on risks that require more immediate attention. S340 is preferably performed by the risk model 102 but can alternatively be performed by another suitable system component. In an alternative variant, S340 can be performed by a trained neural network trained to ingest both a risk profile 10 and a discount profile 20 and output a weighted risk profile 30. In S340, risk profiles 10 are preferably scaled and/or (de-)weighted based on a set of discount profiles 20 (e.g., as determined in S330) thereby determining weighted risk profiles 30 which include a set of weighted risk values; however, S340 can be otherwise performed. As an example, the discount profile(s) 20 can increase the magnitude of risk values of a risk profile for a collision of the ego vehicle with a pedestrian, which would have a higher likelihood to cause harm as compared with a collision between an ego vehicle and a more rigid object (e.g., other vehicle, static object, etc.).

In a first specific example, a risk value of a weighted risk profile 30 can be the risk value from the risk profile 10, multiplied by each of: a discount weight from the discount profile 20 and a probability of the risk occurring. In a second specific example, a risk value of a weighted risk profile 30 can be the risk value from the risk profile 10, multiplied by each of: a discount weight from the discount profile 20 and a probability of another agent performing a behavior (e.g., enacting a policy) which causes the risk.

In variants, S340 can include aggregating the weighted or unweighted risk values across timesteps of a planning horizon, such that an output of S340 is a single aggregated risk score. Examples of aggregation methods can include: summation across all timesteps, percentile-based selection (e.g., 90th percentile, maximum value), weighted averaging with temporal decay factors, integration over a continuous planning horizon, and/or any other suitable mathematical aggregation technique. The aggregation method can be selected based on the desired risk assessment characteristics, such as emphasizing peak risks versus cumulative exposure, and can vary by risk type or policy category. The resulting aggregated risk scores (e.g., weighted risk profiles 30) can enable direct comparison between policy proposals during the election process, facilitating selection of the policy that best balances safety considerations with operational objectives.

However, discounting a set of risks can be otherwise performed.

Additionally or alternatively, S300 can include any other processes and/or be otherwise suitably performed. Additionally, S300 can include any and/or all of the methods and/or process elements for determining and assessing a set of risks encounterable by the ego vehicle as described in U.S. application Ser. No. 18/538,312, filed 13 Dec. 2023, which is incorporated herein in its entirety by this reference.

### 4.4 Method—Selecting a Policy Based on the Set of Risks S400

Selecting a policy based on the set of risks S400 functions to determine a risk-aware control strategy for the vehicle in a decision-making cycle. S400 is preferably performed after S300 but can alternatively be performed at any other suitable time. S400 is preferably performed at each iteration of an MPDM cycle (e.g., at a selection step of the MPDM cycle, etc.) but can alternatively performed according to any other suitable frequency or trigger (e.g., at predetermined intervals, responsive to overall risk exceeding a threshold condition, etc.). In a specific example, the policy selection process utilizes the temporally discounted and/or probability-weighted weighted risk profile(s) 30 to identify policies that maintain optionality for uncertain future scenarios while ensuring appropriate response to imminent or high-probability risks.

In a first variant, S400 includes selecting a policy that minimizes overall risk (e.g., a policy associated with a minimal aggregated weighted risk profile over both the ego vehicle and other agents in the scene). In a second variant, S400 includes selecting a policy that minimizes risk for the ego vehicle alone. In a third variant, S400 includes selecting a policy based on a weighted risk minimization function with different coefficients for the ego vehicle and other vehicles in the scene. However, selection can be otherwise performed.

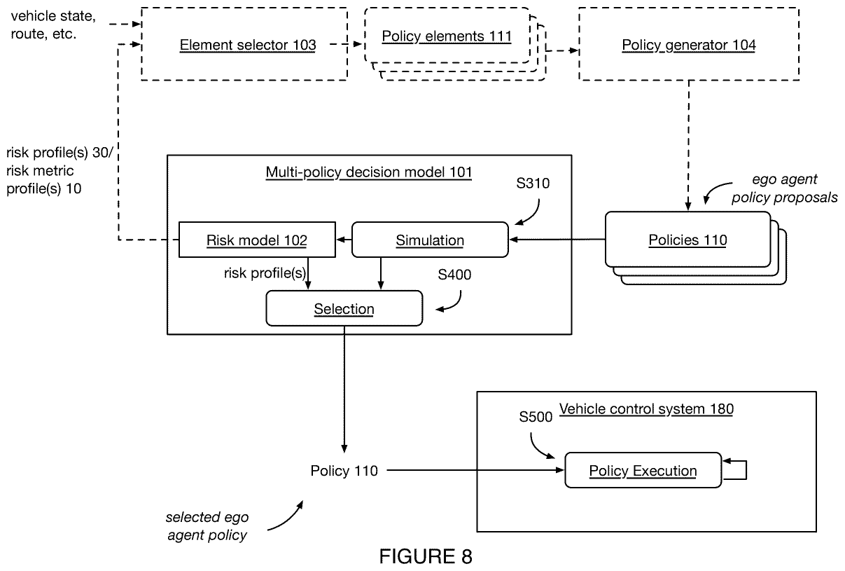

In variants where the policy comparison indicates that no available policy provides an acceptable weighted risk profile, S400 can trigger additional policy generation (e.g., requesting more aggressive evasive maneuvers from the policy generation model), initiate emergency protocols, or request teleoperator intervention. In such variants, S400 can include generating a policy which responds to a risk directly (e.g., example shown in FIG. 8). For example, a finite number of policies can be evaluated within a first (Nth) election cycle (e.g., a predetermined set of fallback policies and policies determined at S200). Within the next (N+1) election cycle, the simulation rollouts and risk evaluations (e.g., response optionality) can be used to generate risk-aware policies in the next (N+1) iteration of S200, which can then be evaluated for risks and used for a subsequent policy election at S400. Accordingly, the temporal response optionality can be evaluated (e.g., via S400) subsequent election cycles (e.g., until the risk is no longer present and/or the vehicle elects to respond, given sufficient urgency). In variants in which S400 includes policy generation, policy generation may be performed using any of the processes described in U.S. application Ser. No. 19/269,394 filed 15 Jul. 2025, which is incorporated herein in its entirety by this reference.

The system may also adjust the discount weights to reassess whether more conservative temporal weighting reveals acceptable policy options.

In variants, the weighted risk values (e.g., weighted risk profile 30) can be used as one of a plurality of inputs to a policy selection process. In such variants, S400 can optionally include calculating a reward value, which functions to assess how much the ego vehicle would progress toward a goal (e.g., reduce its distance to a destination, obey traffic rules, etc.), which can optionally be incorporated in the decision-making (e.g., policy selection) of the ego vehicle. In a first set of variations, the decision-making in S400 is performed in a hierarchical (e.g., decision tree) fashion, wherein a reward value is only calculated in an event that no risks are detected in S300 and/or any risks detected in S300 can be avoided. In a set of examples, in an event that no potential hazardous event is detected, other lower tiers of events (e.g., legal risk events, comfort risk events, delay risk events, etc.) can be considered (e.g., prior to a reward value). In a second set of variations, a reward value can be aggregated with one or more risk values (e.g., total energy, modified kinetic energy, modified kinetic energy aggregated with work, etc.) to determine an overall score for each policy.

S400 preferably includes selecting a policy (e.g., action, behavior, etc.) for the ego vehicle based on the risk and/or reward values and maneuvering the vehicle according to that policy. This can include, for instance, assessing the risk over the whole simulation/policy rollout (e.g., 8 seconds), such as aggregating risks over all time steps, discounting risks at future time steps if objects can brake sufficiently or otherwise avoid the risk, pushing risks farther into the future (e.g., by slowing down), and/or otherwise analyzing risk. For instance, S400 can leverage the different simulation rollouts to estimate if the likelihood of a conflict is increasing or decreasing based on what the ego vehicle is doing or planning to do (e.g., by referencing historical rollouts and analyzing if the risk is going up or down), and selecting a policy based on that (e.g., changing to a new policy if the risk continues to increase with the same policy, maintaining a same policy if the risk continues to decrease, etc.).

Additionally or alternatively, risk can be otherwise suitably compared and selected from different policy proposals (e.g., an example is shown in FIG. 2). Additionally or alternatively, S400 can include any other suitable processes.

However, selecting a policy can be otherwise performed.

### 4.5 Method—Operating the Ego Vehicle Based on the Set of Risks S500

The method can optionally include operating the ego vehicle based on the assessed risks S500, which functions to optimally respond to the risks based on the risk features, values, and/or scores characterized in S300. Additionally or alternatively, S500 can perform any other functions. S500 can be performed during a multi-policy decision-making process of the ego vehicle (e.g., as described above), but can additionally or alternatively be performed in accordance with any other decision-making processes of the ego vehicle. For example, S500 can include controlling a vehicle powertrain, brakes, steering system, and/or any other suitable vehicle system.

In a first set of variants, S500 can select a policy based on the risk evaluation/scores.

In a second set of variants, nonexclusive with the first, S500 can generate a policy which responds to a risk directly (e.g., within an N+1 election cycle). For example, a finite number of policies can be evaluated within a first (Nth) election cycle (e.g., a predetermined set of fallback policies and policies determined at S200). Within the next (N+1) election cycle, the simulation rollouts and risk evaluations (e.g., response optionality) can be used to generate risk-aware policies in the next (N+1) iteration of S200, which can then be evaluated for risks and used for a subsequent policy election at S400. Accordingly, the temporal response optionality can be evaluated (e.g., via S500) subsequent election cycles (e.g., until the risk is no longer present and/or the vehicle elects to respond, given sufficient urgency).

The method can additionally or alternatively include any other processes, such as, but not limited to, any or all of: repeating any or all of the above processes (e.g., to see if an avoidable risk evolves into an unavoidable risk, to see if an avoidable risk goes away, etc.), and/or any other suitable processes.

All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

All or portions of the method can be performed by one or more components of the system, using a computing system, using a database (e.g., a system database, a third-party database, etc.), by a user, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for a vehicle, comprising:
based on a set of measurements depicting a set of agents in an environment surrounding the vehicle, determining a virtual representation of the set of agents;
determining a set of candidate behavior policies for the vehicle;
during vehicle operation, for a candidate behavior policy of the set of candidate behavior policies:
based on the candidate behavior policy and the virtual representation of the set of agents, dynamically determining a risk profile associated with the set of agents, the risk profile representing risk at each of a set of timesteps in a planning horizon;
dynamically determining a set of risk discount profiles, wherein each risk discount profile varies over timesteps in a planning horizon; and
according to the set of risk discount profiles, determining a set of weighted risk parameters for the risk profile;
based on the set of weighted risk parameters, selecting the candidate behavior policy from the set of candidate behavior policies;
determining a set of vehicle controls based on the selected candidate behavior policy; and
using the set of vehicle controls, controlling the vehicle.

2. The method of claim 1, wherein determining the risk profile comprises performing a forward simulation of the candidate behavior policy.

3. The method of claim 2, wherein determining the risk profile comprises aggregating risks from multiple forward simulations of the candidate behavior policy, wherein policies for the set of agents in the environment differ between simulations of the multiple forward simulations.

4. The method of claim 3, wherein the multiple forward simulations are determined using sampling from a probability distribution of different policies being implemented by the agents in the environment.

5. The method of claim 2, wherein each risk profile is based on a control effort of the vehicle within a simulation of the vehicle implementing the candidate behavior policy.

6. The method of claim 1, wherein each risk profile is further based on a set of control effort of the set of agents in the environment.

7. The method of claim 1, wherein a risk discount profile of the set of risk discount profiles is based on a probability of an agent in the environment performing an agent behavior policy.

8. The method of claim 7, wherein the probability of the agent performing the agent behavior policy is determined by sampling from a plurality of forward simulations of agent behavior.

9. The method of claim 1, wherein a risk discount profile of the set of risk discount profiles is based on a kinematic state of the vehicle.

10. The method of claim 9, wherein a region of the risk discount profile is constant over a temporal subregion of the planning horizon.

11. The method of claim 10, wherein a length of the temporal subregion is based on a speed of the vehicle.

12. The method of claim 1, wherein determining the weighted risk parameters comprises stable binning of the risk profile, each bin weighted according to the risk discount profile.

13. The method of claim 1, wherein the set of risk discount profiles are output from a neural network.

14. A method for a vehicle, comprising:
during vehicle operation:
dynamically determining a risk profile associated with a set of agents in an environment of the vehicle, wherein each risk parameter of the risk profile corresponds to a respective timestep in a planning horizon; and
dynamically determining a risk discount profile, wherein weights of the risk discount profile vary over timesteps in a planning horizon; and
according to weights of the risk discount profile, determining a set of weighted risk parameters for the risk profile;
based on the set of weighted risk parameters, selecting a candidate behavior policy from a set of candidate behavior policies; and
controlling the vehicle based on the selected candidate behavior policy.

15. The method of claim 14, wherein determining the risk profile comprises predicting control effort exerted by the vehicle at each timestep of the planning horizon using a forward simulation over the planning horizon.

16. The method of claim 15, wherein determining the risk profile comprises aggregating, for each timestep of the planning horizon, the predicted control effort exerted by the vehicle across multiple distinct simulations of the candidate behavior policy.

17. The method of claim 16, wherein the forward simulation comprises a simulation of the vehicle implementing the candidate behavior policy and a simulation of the set of agents in the environment implementing agent behavior policies selected from a probability distribution.

18. The method of claim 15, wherein determining the risk profile further comprises predicting a control effort exerted by an agent of the set of agents over the planning horizon in the forward simulation.

19. The method of claim 14, wherein the risk discount profile is based on a current speed of the vehicle.

20. The method of claim 14, wherein determining the set of weighted risk parameters for the risk profile comprises applying stable binning to the set of weighted risk parameters.
